(19) United States
(12) Patent Application Publication
(10) Pub. No.: US 2023/0280071 A1
(43) Pub. Date: Sep. 7, 2023

(54) Linear Solar Tracking Array

(71) Applicant: William Otis Walden, Bridgeport, TX (US)

(72) Inventor: William Otis Walden, Bridgeport, TX (US)

(21) Appl. No.: 17/539,274

(22) Filed: Dec. 1, 2021

(51) Int. Cl. F24S 30/45; F24S 23/70; H02S 20/32

(52) U.S. Cl. CPC F24S 30/45; F24S 23/81; H02S 20/32; F24S 2030/133

(57) ABSTRACT

The present invention comprises at least two independently maneuverable panels, either reflective of photovoltaic, arranged linearly, and physically interconnected to at least one common control capable of moving the panels simultaneously. Each panel is mounted on a separate support allowing it to be pivoted from side-to-side and/or up-and-down independently of the other panels. The preferred embodiment will permit every panel in series to be moved in unison using two main cables. This apparatus is further designed to track the sun along two-axes-both side-to-side and up-and-down-while maintaining constant tension on these cables throughout all degrees of freedom permitted by design. The apparatus also permits each mirror to be focused independently on a smaller target by means of mirror warping.

### FIELD OF THE INVENTION

The present invention relates to methods for tracking the sun for solar power applications. More particularly, the invention relates to tracking devices designed to maximize solar energy captured by adsorptive surfaces.

### BACKGROUND

The growing interest in renewable energy is being driven as much by economics as by global climate change. There have been significant advances in the development of new methods for harnessing solar power, particularly concentrated solar power (CSP), in which movable mirrors, known as heliostats, are used to reflect the sun’s rays onto an absorptive target. The vast number of such reflectors required to generate the requisite heat for a CSP facility typically accounts for up to 40% of the capital costs.

A majority of the heliostats in operation are planar arrays of mirrors moved as one on massive frames. These frames must be stiff to withstand high winds, as do their supporting structures, and thus require powerful motors to move in accordance with the sun. Independently controlled heliostats, on the other hand, are lower to the ground, and therefore require less substantial frames and supporting structures. They are also smaller, reflecting a smaller area than a grouped, planar array of similarly sized mirrors, reducing the size of the tower needed to support a target for capturing their reflections, which can also accounts for a major proportion of construction costs. Individually controlled mirrors, however, each require their own drive mechanism, which is generally the most expensive component of any tracking system.

In an effort to produce a more affordable heliostat, the National Renewable Energy Laboratory (NREL) has developed a cable-stayed apparatus for supporting a planar array of mirrors. The support frame’s weight was reduced significantly, but the base support remained substantial in order to maintain sufficient rigidity and keep the mirrors on target, especially in high winds.

A need therefore remains to further minimize the costs of manufacturing, deploying, and operating heliostats capable of maintaining their collective solar reflections on the smallest target possible.

### BRIEF SUMMARY OF THE INVENTION

The present invention comprises at least two independently maneuverable panels, either reflective of photovoltaic, arranged linearly, and physically interconnected to at least one common control capable of moving the panels simultaneously. Each panel is mounted on a separate support allowing it to be pivoted from side-to-side and/or up-and-down independently of the other panels. The preferred embodiment will permit every panel in series to be moved in unison using two main cables. This apparatus is further designed to track the sun along two-axes-both side-to-side and up-and-down—while maintaining constant tension on these cables throughout all degrees of freedom permitted by design. The apparatus also permits each mirror to be focused independently on a smaller target by means of mirror warping.

### BRIEF DESCRIPTION OF THE DRAWINGS

A clear understanding of the key features of the invention summarized above may be had by reference to the appended drawings, which illustrate the method and function of the apparatus, although it should be understood that such drawings depict preferred embodiments of the invention and, therefore, are not to be considered as limiting its scope with regard to other embodiments which the invention is capable of contemplating. Accordingly:

FIG. 1 - FIG. 1 depicts a side view of a linear solar tracking array incorporating the various embodiments described herein.

FIG. 2 - FIG. 2 depicts a top-down perspective view of a linear solar tracking array incorporating the various embodiments described herein.

FIG. 3 - FIG. 3 depicts the front view of a panel with holes for attachment to a frame.

FIG. 4 - FIG. 4 depicts a side view of a standard articulated support assembly with attached panel.

FIG. 5 - FIG. 5 depicts a back view of a standard articulated support assembly with attached panel.

FIG. 6 - FIG. 6 depicts a side view of a rear articulated support assembly with attached panel.

FIG. 7 - FIG. 7 depicts a back view of a rear articulated support assembly with attached panel.

FIG. 8 - FIG. 8 depicts a side view of the mast with pulleys for tensioning the two common control cables.

FIG. 9 - FIG. 9 depicts a back view of the mast assembly.

FIG. 10 - FIG. 10 depicts an expanded side view of the apparatus (FIG. 1), focusing on the rear articulated support assembly (FIG. 6), and particularly on the routing and function of support cables and common controls.

FIG. 11 - FIG. 11 depicts a side view of a support base with guide pulleys.

FIG. 12 - FIG. 12 depicts a side view of a support frame.

FIG. 13 - FIG. 13 depicts a back view of a support frame.

FIG. 14 - FIG. 14 depicts a side view of a support frame with attached panel.

FIG. 15 - FIG. 15 depicts an expanded side view of a support frame with attached panel, focusing on the top point of attachment.

FIG. 16 - FIG. 16 depicts a side view of a standard tailpiece.

FIG. 17 - FIG. 17 depicts a back view of a standard tailpiece.

FIG. 18 - FIG. 18 depicts a top view of a standard tailpiece with guide pulleys.

FIG. 19 - FIG. 19 depicts a side view of a rear tailpiece.

FIG. 20 - FIG. 20 depicts a back view of a rear tailpiece.

FIG. 21 - FIG. 21 depicts a top view of a rear tailpiece with guide pulleys.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and components are disclosed. Each of these has individual benefit and each can also be used in conjunction with one or more, or in some cases all, of the other disclosed components and techniques. Accordingly, for the sake of clarity, this description will refrain from repeating every possible combination of the individual steps in an unnecessary fashion. The specification and claims should be read with the understanding that such combinations are entirely within the scope of the invention and the claims, and that those in the art will understand that a number of variations may be made in the disclosed embodiments, all without departing from the scope of the invention, which is defined solely by the appended claims.

The present disclosure is to be considered as an exemplification of the present invention, and is not intended to limit the invention to the specific embodiments illustrated by the figures or description below. For purposes of explanation, numerous specific details are set forth in order to provide a thorough understanding of the present invention.

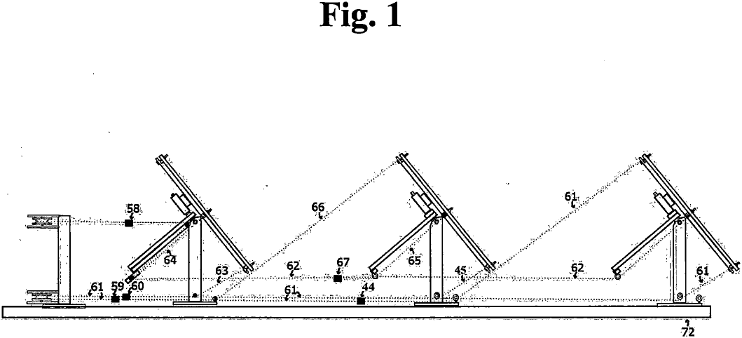

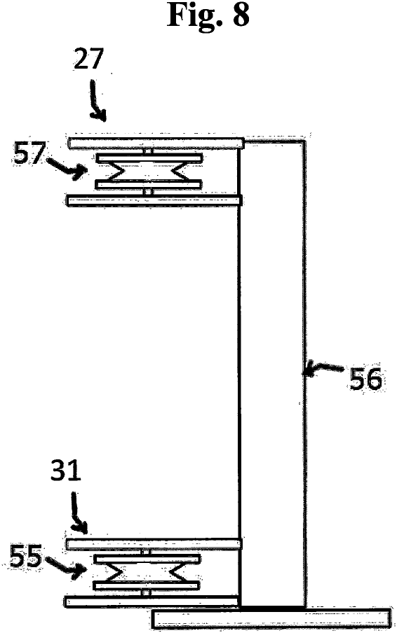

The present invention regarding a linear solar tracking array will be henceforth referred to as the ‘apparatus’ and the terms ‘front’, ‘back’, ‘left’, and ‘right’ are in reference to the example of an apparatus as depicted in FIG. 1, whereby ‘front’ of the apparatus refers to the end of the array near the top right of the page, opposite the mast (FIG. 8.

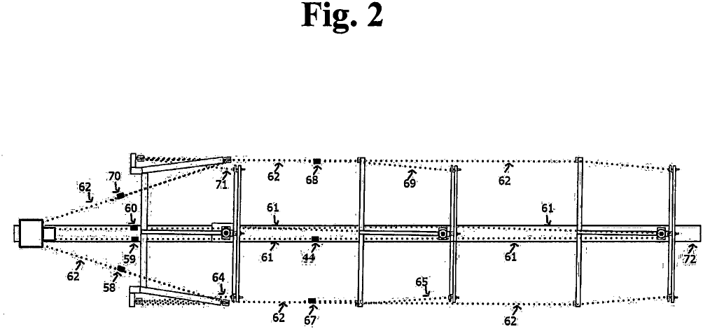

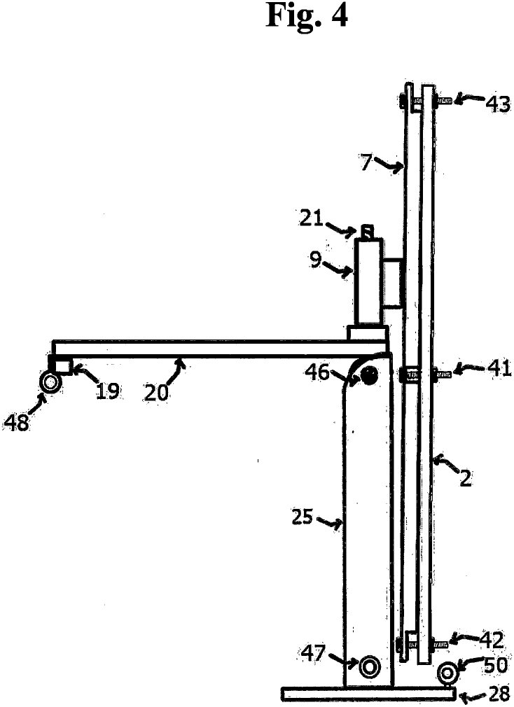

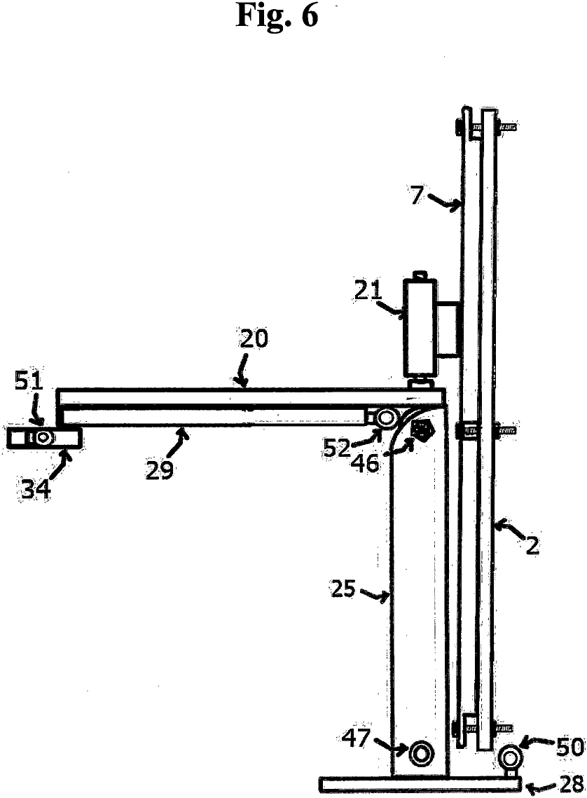

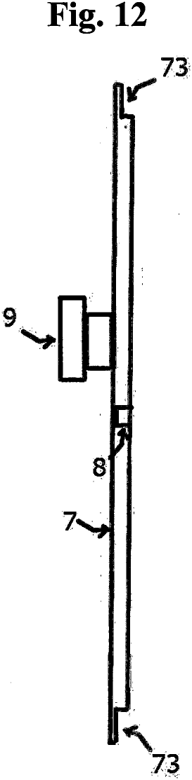

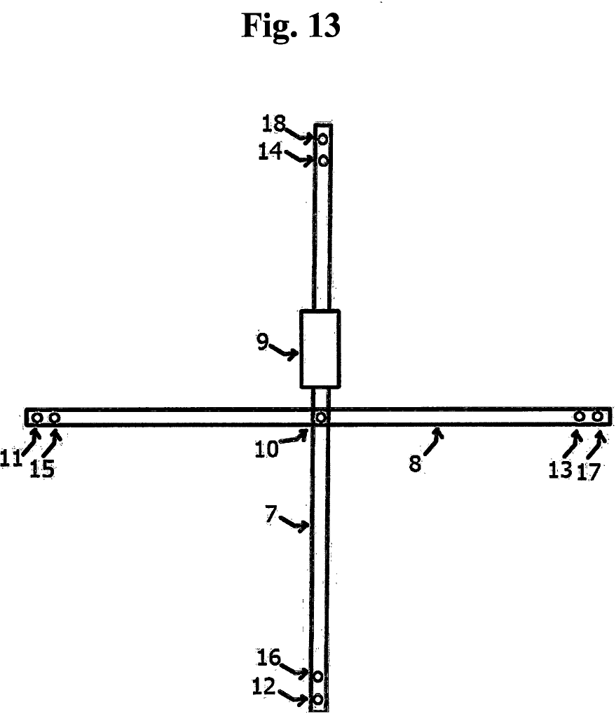

The present invention will now be described by referencing the appended figures representing preferred embodiments. FIG. 1 depicts elements that may comprise an apparatus according to various embodiments of the present invention. In preferred embodiments the apparatus is configured with at least one mast assembly (FIG. 8), one rear articulated support assembly (FIG. 6), and at least one standard articulated support assembly (FIG. 4). FIG. 1 depicts a side view of the apparatus comprising one mast (FIG. 8) one rear articulated support assembly (FIG. 6) and two standard articulated supports assemblies (FIG. 4). The embodiment depicted by FIG. 1 and FIG. 2 is merely a representational example of the apparatus for the purpose of demonstration. At minimum the apparatus may comprise and one standard articulated support assembly (FIG. 4). The preferred embodiment may comprise multiple standard articulated support assemblies (FIG. 4). The mast and articulated support assemblies in this example are attached at their bases (28 of FIG. 4) to an optional common beam (72 of FIG. 1). The cables (61, 62 of FIG. 1), henceforth termed “common controls,” may serve to provide both stability and a method for pivoting the articulated support assemblies in a synchronous manner up-and-down and/or side-to-side. The common controls are held under tension by the mast assembly (FIG. 8), are connected at either ends to the first standard articulated support assembly (FIG. 12) at the front of an array and opposite the mast end directly via cables (61, 62 of FIG. 2), or indirectly via support cables (64, 65, 69, 71 of FIG. 2) and (45, 63, 65, 66 of FIG. 1). The support cables may be attached at one end to holes (11,12,17,18 of FIG. 13) on the panel support frames and to the control cables (61,62 of FIG. 2) via cable clamps (44, 58, 59, 60, 67, 68, 70 of FIG. 2). The compositions of support cables and common controls are not limited to the constructional detail shown or described in the accompanying text. A preferred embodiment may employ the use of steel cables for the common controls, but those of skill in the art will understand a suitable common control may be fabricated from various other materials, comprising, but not limited to other metals, manmade polymers, natural fibers, etc., and may be substituted by comparable methods for linking, staying, and moving components, including, but not limited to wire, rope, chains, rods, etc., and/or any combination thereof.

FIG. 2 depicts a top-down perspective view of the apparatus comprising one mast (FIG. 8) one rear articulated support assembly (FIG. 6) and two of the standard articulated supports as shown in (FIG. 4).

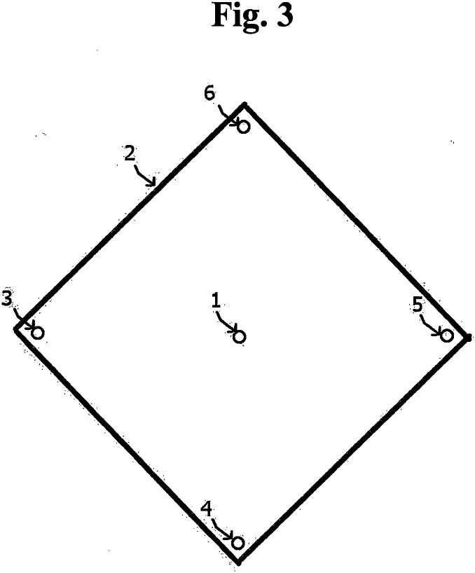

The front view of reflective panel (2 of FIG. 3) has five holes (1,3,4,5,6 of FIG. 3) for mounting to respective holes (10,15,16,13,14 of FIG. 13) in the support frame. The present example employs the use of nuts and bolts for attaching a panel but does not preclude any alternative methods for attachment to a frame, such gluing, riveting, taping, etc., and/or some combination thereof. The panels may be reflective or photovoltaic depending on application. If reflective, the panels may be comprised of a variety of materials, including, but not limited to glass, polymer, metal, etc., and/or some combination thereof.

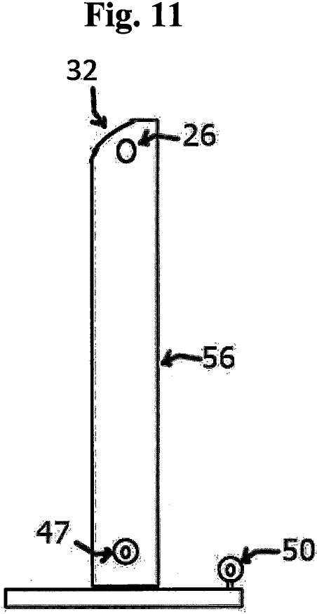

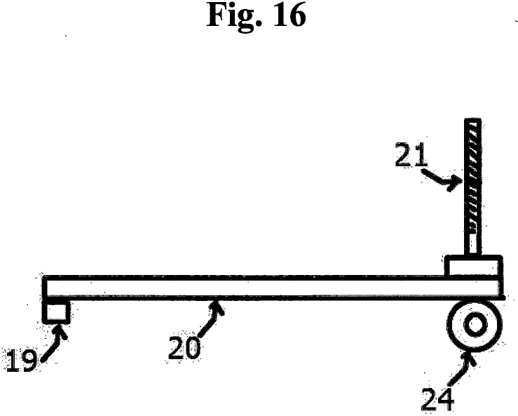

FIG. 4 depicts a side view of a standard articulated support assembly with attached reflective panel (2 of FIG. 3) and guide pulleys (47,48,50 of FIG. 4). The guide pulleys may route both common controls and support cables to ensure proper orientation and smooth operation of functional elements. The standard articulated support assembly depicted (FIG. 4) is a merely composite drawing of three parts and the numbered parts shown not described here will be described in detail for the individual parts comprising it. This standard articulated support assembly comprises a support base (FIG. 11), a support frame (FIG. 12), and a standard tailpiece (FIGS. 16, 17, 18). The vertical swivel (24 of FIG. 16) of the standard tailpiece is attached to the support base via a bolt (46 of FIG. 4) and allows the panel support to tilt substantially from the vertical position illustrated in FIG. 4 to a more horizontal position. The vertical bolt (21 of FIG. 16) of the standard tailpiece is attached to the horizontal swivel (9 of FIG. 12) of the panel support, allowing the panel support to pivot from side-to-side irrespective of tilt angle. The use of bolts and swivels for providing freedom of movement along two axes about a common center of rotation is merely illustrative and does not preclude the use of other methods for achieving a comparable effect, such as a ball-and-socket joint, etc., or any combination of alternate methods thereof.

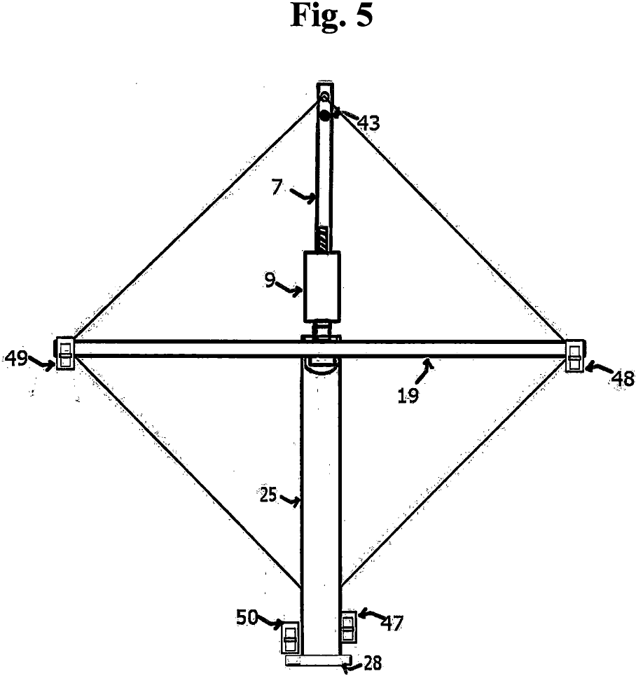

FIG. 5 depicts a back view of a standard articulated support assembly with attached panel (2 of FIG. 3) and guide pulleys (47,48,49,50 of FIG. 5).

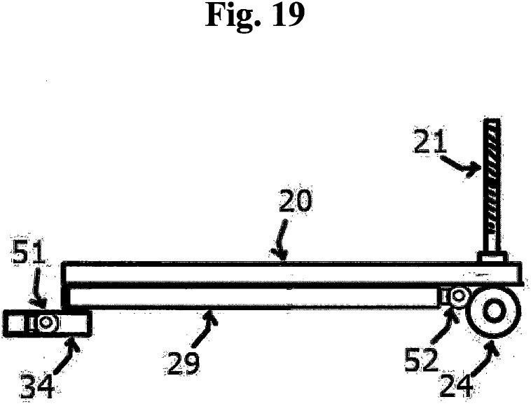

FIG. 6 depicts a side view of a rear articulated support assembly with attached panel (2 of FIG. 3) and guide pulleys (47,50,51,52 of FIG. 6). The rear articulated support assembly depicted is identical to a standard articulated support assembly (FIG. 4) with respect to having a support base (FIG. 11) and support frame (FIG. 12), differing only in that it has a rear tailpiece (FIG. 19) in place of a standard tailpiece (FIG. 16). The rear articulated support assembly allows its support frame freedom of movement from side-to-side and up-and-down, while providing consistent tension on the common control cables (61,62 of FIG. 1) throughout all degrees of freedom permitted by design.

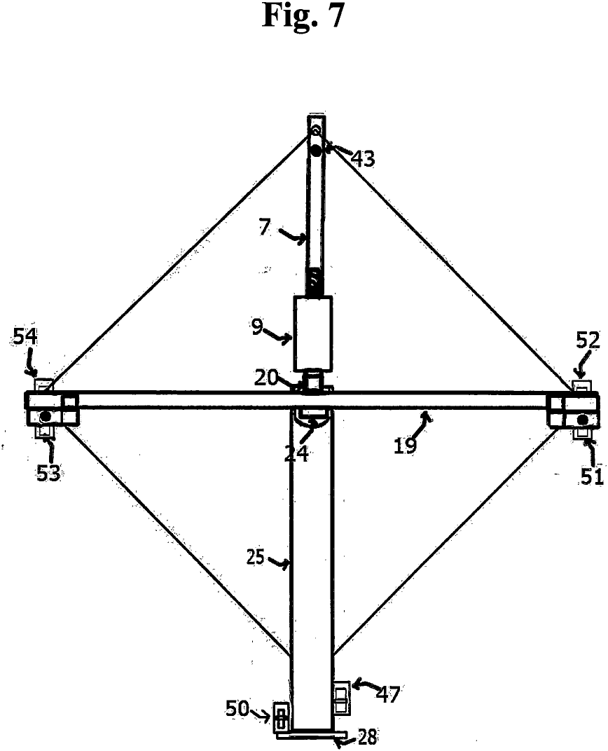

FIG. 7 depicts a back view of a rear articulated support assembly with attached panel (2 of FIG. 3) and guide pulleys (47,50,51,52,53,54 of FIG. 7).

FIG. 8 depicts a side view of a mast (56) with pulleys (55,57). The top pulley (57) is supported by top bracket (27) and provides tension for the top common control (62) cable and enables its movement. Because this top cable is directly or indirectly connected to the right holes (11 of FIG. 13) and left holes (17 of FIG. 13) of every support frame, its movement will cause all the panels of the apparatus to pivot right or left, respectively, at the same rate. A bottom pulley (55 of FIG. 8) is supported by bottom bracket (31) and provides tension for the bottom common control cable (61 of FIG. 1) and enables its movement. Because this bottom cable is directly or indirectly connected to the top holes (18 of FIG. 13) and bottom holes (12 of FIG. 13) of every support frame, its movement will cause all panels of the apparatus to tilt up or down, respectively, at the same rate. The use of a mast and associated pulleys as depicted in this example is illustrative of one method for both tensioning and moving the control cables and does not preclude the use of other methods and/or devices, such as a bell crank, etc., capable of providing comparable functions. Although it is conceivable that a human may be employed to manually pull on the control cables to move the panels in conjunction with the sun, a preferred embodiment will likely employ the use automated methods for tracking. No illustrations for automation are provided herein, but it should be commonly understood by one having ordinary skill in the art to which this invention belongs that the apparatus may be actuated in many ways, including, but not limited to any combination of gears, sprockets, belts, hoses, electric motors, engines, bell cranks, pneumatics, hydraulics mechanisms, etc.

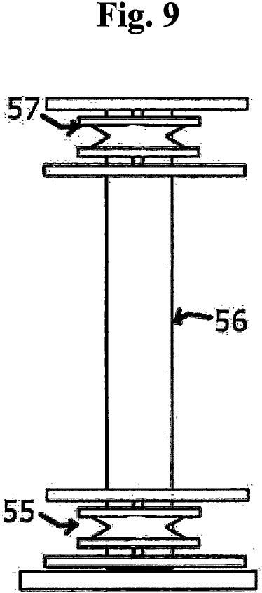

FIG. 9 depicts a back view of a mast with pulleys (55,57).

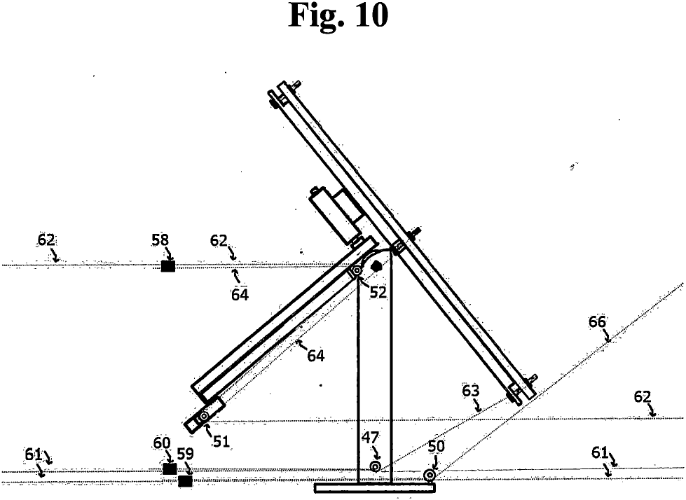

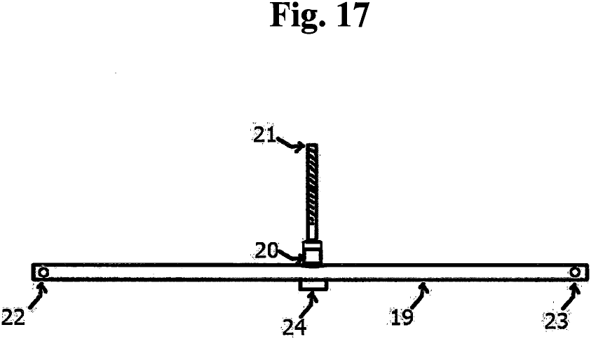

FIG. 10 depicts the rear articulated support assembly (FIG. 6), focusing particularly on the routing and function of support cables and common controls. The top common control (62) cable is routed through pulley (51, 52), as is the right support cable (64), to which the top common control is attached using cable clamp (58). The top common control (62) cable is further routed around the top pulley (57) of the mast (FIG. 8), and is attached the rear articulated support assembly’s left support cable (71 of FIG. 2) using cable clamp (70 of FIG. 2). Because the right and left support cables (64 and 71) depicted in the top-down perspective of the apparatus in FIG. 2 are attached to holes (11 and 17 of FIG. 13) on the support frame at the front of the array, pulling the common control (62) as depicted in FIG. 1 will cause the support fame and panel to pivot in the direction of the pull. The bottom common control (61) cable is routed around tensioning pulley (55 of FIG. 8) on the mast, and is attached to the support cable (63) using cable clamp (60 of FIG. 10). Support cable (63) is attached to hole (12 of FIG. 13) on the support frame, thus pulling on the common control (61) will cause the support frame and panel to pivot up and down. It may be noted that there is no cable shown attached to hole (18 of FIG. 13) of the support frame for the rear articulated support assembly shown in FIG. 10. This is because the rear tailpiece (FIGS. 17,18,19) provides sufficient tension to tilt the support panel upwards by simply relieving the opposing force needed to counteract its natural tendency to tilt downward. All standard articulated support assemblies (FIGS. 4, 5), however, require a physical attachment to hole (18 of FIG. 3) via cables (66, 61 of FIG. 1) to facilitate a downward tilting.

FIG. 11 depicts a side view of the support base (25) used for all types of articulated support assemblies with guide pulleys (47,50). Hole (26) near the top of the base is for attachment via bolt (46) to the vertical swivel (24 of FIG. 17) of the tailpiece. The notch (32) cut out at the top of the support base allows all articulated support assemblies to tilt freely.

FIG. 12 depicts a side view of a support frame with frame with horizontal crossbar (8), vertical crossbar (7) and horizontal swivel (9). The notches (66) cut into both ends of the vertical crossbar are also present of both ends of the horizontal crossbar as well.

FIG. 13 depicts a back view of a support frame with horizontal crossbar (8), vertical crossbar (7), and horizontal swivel (9). Holes (10,13,14,15,16) are for attaching the panel to holes (1,3,4,5,6) in panel (FIG. 3). Holes (11,12,17,18) are for attaching cables.

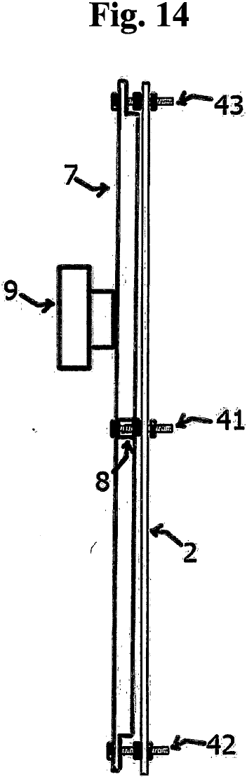

FIG. 14 depicts a side view of a support frame with attached panel. These components are attached together with five bolts via the respective holes in each. The three visible in this perspective are the upper bolt (43), the right bolt (41), and bottom bolt (42).

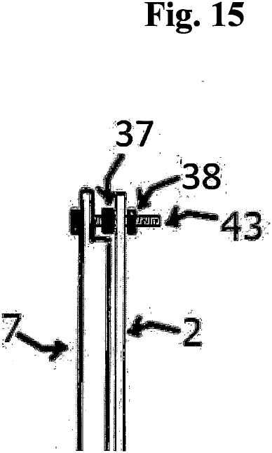

FIG. 15 depicts an expanded side view of a support frame (7) with attached panel (2 of FIG. 3), focusing on the top point of attachment. The top of the horizontal crossbar (8) is attached to panel (2 of FIG. 3) at this point by bolt (43). Because the center hole (1 of FIG. 3) of the panel is affixed to the center hole (10 of FIG. 13) of the support frame, turning the adjustment nuts (37, 38) will cause the panel to be flexed toward or away from the support. The other three ends of the cross bars are similarly attached to the panel. Together they allow for the panel to be warped, such that its reflection may be more finely tuned and/or focused onto a target.

FIG. 16 depicts a side view of a standard tailpiece. It comprises a crossbar (19), extension (20), horizontal swivel (21), and vertical swivel (24). The tailpiece enables for a pull on the common controls (61,62) to pivot the support frame side-to-side and/or up-and-down to the same degree regardless of its initial horizontal or vertical orientation.

FIG. 17 depicts a back view of a standard tailpiece with left (22) and right (23) holes for attaching guide pulleys.

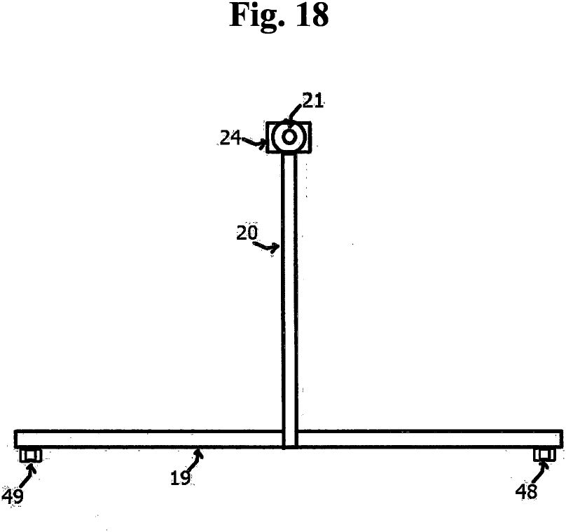

FIG. 18 depicts a top view of a standard tailpiece with left (49) and right (48) guide pulleys.

FIG. 19 depicts a side view of a rear tailpiece with bottom right (51) and top right (52) guide pulleys. This design provides constant tension on the support cables and common controls by routing them through two sets of pulleys aligned to the rear articulated support assembly’s (46 of FIG. 6) vertical center of rotation. This configuration allows the rear articulated support assembly to tilt freely without altering the tension on the control cables.

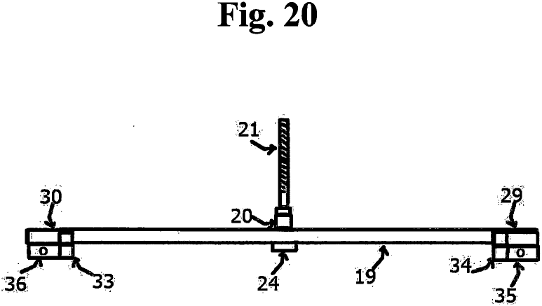

FIG. 20 depicts a back view of a rear tailpiece with holes (35,36) for attaching bottom guide pulleys, the left (33) and right (34) bottom tensioning arms, and the left (30) and right (29) top tensioning arms.

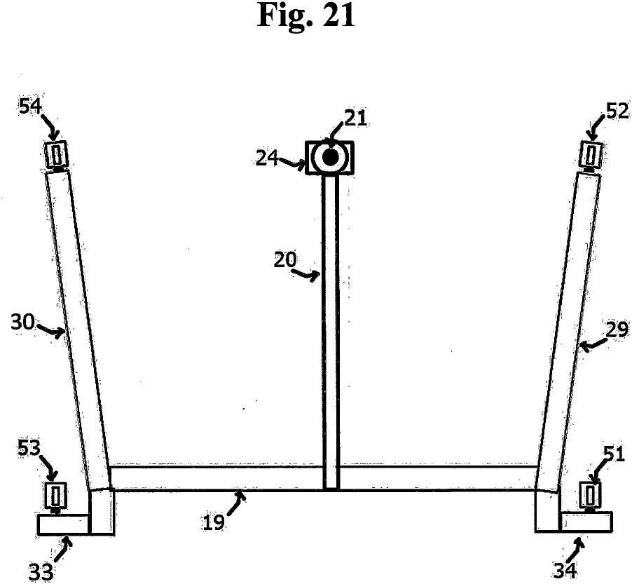

FIG. 21 depicts a top view of a rear tailpiece with guide pulley (51) attached to bottom right tensioning arm (34), guide pulley (53) attached to bottom left tensioning arm (33), guide pulley (52) attached to top right tensioning arm (29), and guide pulley (54) attached to top left tensioning arm (30).

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A solar tracking apparatus comprising:
i a series of at least two independently supported reflective panels; and
ii a physically interconnected means of pivoting said panels.

2. A solar tracking apparatus as in claim 1, wherein said panels are photovoltaic.

3. A panel warping method for focusing its solar reflection onto an external target.
